(19) United States
(12) Patent Application Publication
(10) Pub. No.: US 2008/0256435 A1
(43) Pub. Date: Oct. 16, 2008

(54) Interconnection of Document Preparation, Document Viewing, and Alert Processing in Structured Documents

(75) Inventors: David Gottlieb, Scottsdale, AZ (US); Donald L. Goguen, Fountain Hills, AZ (US); Bodine Rye Blodgett, Phoenix, AZ (US)

Correspondence Address: Kenneth P. Waszkiewicz;Attorney at Law, 29 Murray Avenue, Annapolis, MD, 21401, US

(73) Assignee: CITATION TECHNOLOGIES, INC., Aliso Viejo, CA (US)

(21) Appl. No.: 12/020,436

(22) Filed: Jan. 25, 2008

Related U.S. Application Data
(60) Provisional application No. 60/897,465, filed on Jan. 26, 2007.

(51) Int. Cl. G06F 17/00; G06F 15/16

(52) U.S. Cl. 715/234; 709/206

(57) ABSTRACT

A method and system for notifying a user to review a document stored on a computer. The method scans the document to identify and locate a citation in the document, where the citation is a link to a target document. The method stores the citation in a citations database. The method periodically compares the citations database to a changed documents database. When the comparison determines that the target document is a changed document, the method stores an entry in a hits database, where the entry identifies the document, the citation, and the target document. The method sends an alert message to the user to request that the user review the entry in the hits database.

### CROSS-REFERENCE TO A RELATED APPLICATION

This application for letters patent is related to, and incorporates by reference, U.S. Provisional Patent Application Ser. No. 60/897,465, titled “Interconnection of Document Preparation, Document Viewing, and Alert Processing in Structured Documents”, and filed on Jan. 26, 2007.

### BACKGROUND OF THE INVENTION

1. Field of the Invention

The present invention relates, in general, to computing system content and document management. In particular, the present invention is a method for interconnecting document preparation, document viewing, and alert processing in structured documents.

2. Description of the Related Art

The advent of the Internet provided capabilities that have changed the basic nature of documents in many ways. First, the desire to make documents available on web browsers led to the need for specialized document editors that took advantage of features made available by browsers, and also lived within their limitations. Second, a new dimension was added to documents with the ability to jump from a location in one document to another location in a different document. The phrase “hypertext linking”—often shortened to simply “linking”—was invented to describe this process. This second change, hypertext linking, is arguably the most revolutionary feature of Internet documents.

For hypertext linking to be most effective, documents need to have a structure or organization (i.e., the documents must contain text blocks that other documents can reference). Each hypertext link or reference to a document—a “citation”—is usually constructed by naming the document set, the document, and the location within this document, such as a section or paragraph.

For example, the New Jersey Administrative Code includes state regulations that are divided into titles and chapters. Each chapter is a document that is further subdivided into subchapters, sections, and paragraphs. Thus, a document would include the citation “N.J.A.C. 7:1E-4.10(a)” to link to the New Jersey Administrative Code, title 7, chapter 1E, subchapter 4, section 10, paragraph (a). Since the New Jersey Administrative Code is divided into titles, chapters, subchapters, sections, and paragraphs, other documents can reference and link to portions of the New Jersey Administrative Code as small as a paragraph. This is the nature and importance of Internet documents being “structured”.

One of the problems with hypertext linking is that the document which is referenced and linked-to may change at any time, and the change may make the reference and link either obsolete or incorrect. For example, consider a document which contains the text “The regulations of the state of New Jersey (N.J.A.C. 7:1E-4.10) permit a generator of hazardous waste to dispose of the waste in dry river beds.” When a user clicks the hypertext link N.J.A.C. 7:1 E-4.10, the web browser will jump to the text of the New Jersey Administrative Code, title 7, chapter 1E, subchapter 4, section 10 on another website. If New Jersey changes the text of this referenced section in the future to state, rather, that such disposal is no longer permitted, then the original document that includes the hypertext link N.J.A.C. 7:1E-4.10 would be incorrect. Furthermore, in this example, the text pointed to by the hypertext link and the text of the original document would be contradictory.

There is a demand for a system and method that notifies a user to review a structured document that includes a hypertext link to a target document when the target document has changed. There is also a demand for a system and method that notifies the user to review the structured document that includes a hypertext link to a document element of a target document when the document element of the target document has changed. The presently disclosed method and system satisfies these demands.

### SUMMARY OF THE INVENTION

A method and system for notifying a user to review a document stored on a computer. The method scans the document to identify and locate a citation in the document, where the citation is a link to a target document. The method stores the citation in a citations database. The method periodically compares the citations database to a changed documents database. When the comparison determines that the target document is a changed document, the method stores an entry in a hits database, where the entry identifies the document, the citation, and the target document. The method sends an alert message to the user to request that the user review the entry in the hits database.

In one embodiment, the document is a structured document and the citation is a hypertext link to the structured document. In another embodiment, the target document is a structured target document that includes a number of document elements and the citation is a link to one of the document elements in the structured target document. When the method performs the comparison for a structured target document, the comparison determines that the structured target document is a changed document when the change is to the document element to which the citation is linked.

When the user receives the alert message and decides to review the entry in the hits database, the method creates a dynamic web page by merging the document with data obtained from other sources, including the citations database, the hits database, and a document library, and displays the dynamic web page. In one embodiment, the user may decide to review the entries in the hits database without receiving an alert message. If the user determines that the change to the target document necessitates a change to the document, the user edits the dynamic web page to reflect the change to the target document. In one embodiment, when the user views the dynamic web page using a browser program, the appearance of each citation in the dynamic web page that is also in the hits database will differ from the appearance of other citations.

### BRIEF DESCRIPTION OF THE DRAWINGS

FIG. 1 is a network diagram that illustrates the hardware components comprising an exemplary embodiment of a system and method for notifying a user to review a document stored on a computer.

FIG. 2 is a block diagram that illustrates an exemplary embodiment of the system components, comprising hardware and software, shown in FIG. 1.

FIG. 3 is a flow chart that illustrates an exemplary embodiment of the method for notifying a user to review a document stored on a computer.

### DETAILED DESCRIPTION OF THE INVENTION

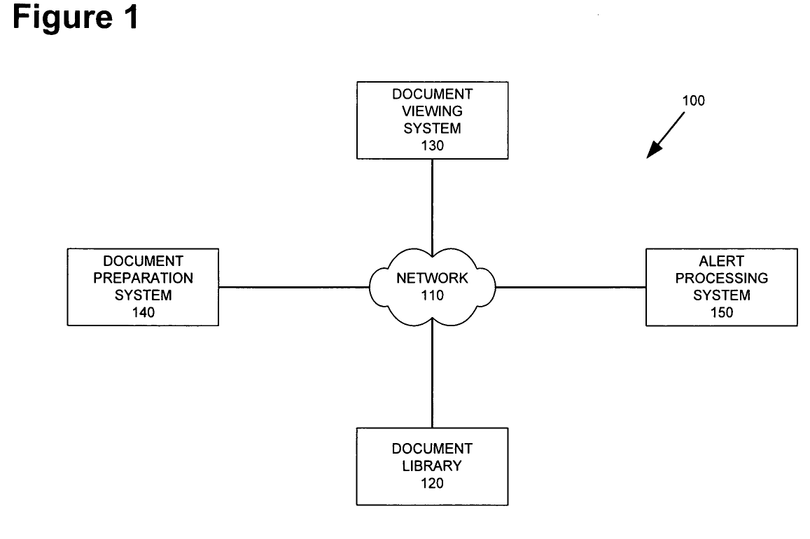

FIG. 1 is a network diagram that illustrates the hardware components comprising an exemplary embodiment of a system and method for notifying a user to review a document stored on a computer. The system 100 components include a document library 120, a document viewing system 130, a document preparation system 140, and an alert processing system 150 that communicate via a network 110.

The network 110 shown in FIG. 1, in an exemplary embodiment, is a public communication network that connects and enables data transfer between the document library 120, document viewing system 130, document preparation system 140, and alert processing system 150. The system and method for notifying a user to review a document stored on a computer also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA) or Code Division Multiple Access (CDMA) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

The document library 120 is accessible by all of the other components in the system 100 of the present invention. The document library 120 may contain both structured and unstructured documents. If the document is a structured document, a link to the document can refer to any structural element within the document, such as a section or paragraph. If the document is an unstructured document, a link to the document can only refer to the document level, the highest link level in the document.

The document viewing system 130 includes processes that access the document library 120 to obtain documents and present those documents to a display program such as an Internet browser to display the documents for viewing by a user. These processes create Internet pages, as requested, by merging documents in the document library 120 with data obtained from other sources, such as database tables, user preferences, user input, or other processes. This document creation by merging is often referred to as “dynamic page generation”.

The document preparation system 140 includes processes that create and edit documents. The creation and editing of the documents may be performed manually by a user or may be an automated process. Processes in the document preparation system 140 deposit these documents into the document library 120 after the creation and editing are complete and the documents are ready for viewing via the document viewing system 130.

The alert processing system 150 includes processes that track changes to documents in the document library 120. When the alert processing system 150 detects a change to a document, an alert is sent to the owner of the document through the document viewing system 130 and/or the document preparation system 140.

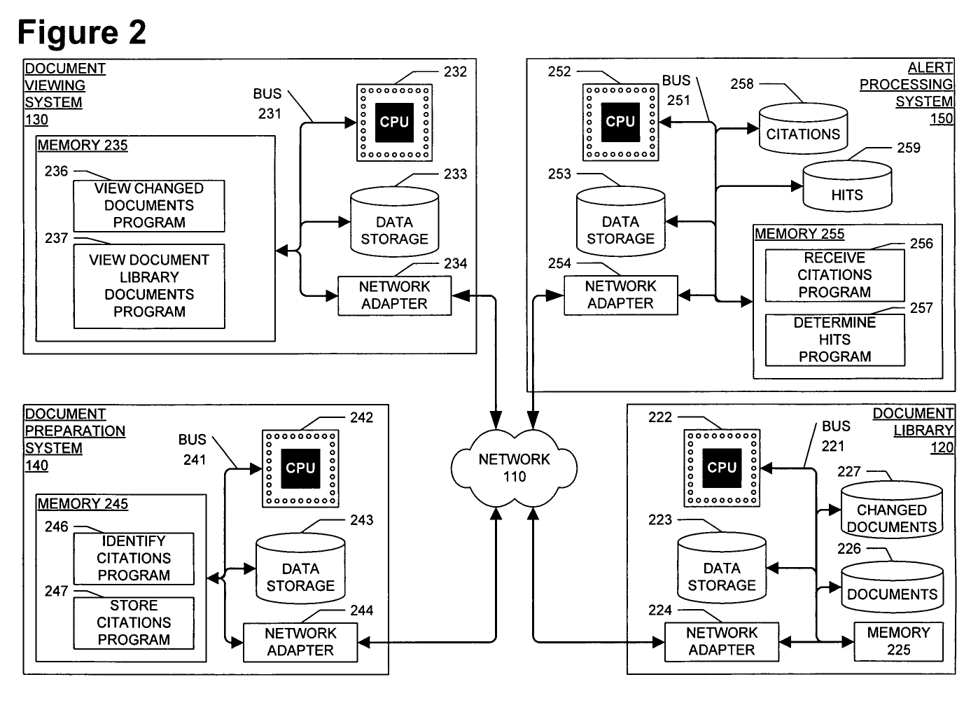

FIG. 2 is a block diagram that illustrates an exemplary embodiment of the system components, comprising hardware and software, shown in FIG. 1. FIG. 2 illustrates the hardware and software components for the document library 120, document viewing system 130, document preparation system 140, and alert processing system 150 that perform the method of the present invention by keeping structured documents current with changes in other documents. In the exemplary embodiment shown in FIG. 2, the document library 120, document viewing system 130, document preparation system 140, and alert processing system 150 reside on separate general-purpose computers. In other exemplary embodiments, the document library 120, document viewing system 130, document preparation system 140, and alert processing system 150 may not reside on separate general-purpose computers, but may be consolidated to reside on fewer general-purpose computers, or on a single general-purpose computer.

The document library 120 shown in FIG. 2 is a general-purpose computer. A bus 221 is a communication medium that connects a central processor unit (CPU) 222, data storage 223, network adapter 224, memory 225, documents 226 database, and changed documents 227 database. The network adapter 224 also connects to the communication network 110 and is the mechanism that facilitates the passage of network traffic between the document library 120 and the network 110. The CPU 222 performs the disclosed methods by executing the sequences of operational instructions that comprise each computer program resident in, or operative on, the memory 225. It is to be understood that the memory 225 may include operating system, administrative, and database programs that support the programs disclosed in this application. These computer programs store intermediate results in the memory 225 or data storage 223.

The document viewing system 130 shown in FIG. 2 is a general-purpose computer. A bus 231 is a communication medium that connects a CPU 232, data storage 233, network adapter 234, and memory 235. The network adapter 234 also connects to the communication network 110 and is the mechanism that facilitates the passage of network traffic between the document viewing system 130 and the network 110. The CPU 232 performs the disclosed methods by executing the sequences of operational instructions that comprise each computer program resident in, or operative on, the memory 235. It is to be understood that the memory 235 may include operating system, administrative, and database programs that support the programs disclosed in this application.

In one embodiment, the configuration of the memory 235 includes a VIEW CHANGED DOCUMENTS program 236, and VIEW DOCUMENT LIBRARY DOCUMENTS program 237. These computer programs store intermediate results in the memory 235 or data storage 233. These programs both access the hits 259 database and display the results to the user. In another embodiment, the memory 235 may contain one of these programs, but not both programs.

The VIEW CHANGED DOCUMENTS program 236 allows the user to view the data in the hits 259 database and to link from there to the changed documents 227 database. The VIEW CHANGED DOCUMENTS program 236 implements a MARK IT CLOSED function which allows the user to indicate that each record in the hits 259 database has been reviewed and appropriate action has been taken. The closure status via the MARK IT CLOSED function is stored in the hits 259 database. In another embodiment, the VIEW CHANGED DOCUMENTS program 236 also implements other functions, such as entering a comment along with the closure status.

The VIEW DOCUMENT LIBRARY DOCUMENTS program 237 allows the user to retrieve documents stored in the documents 226 database from the document library 120 and view those documents. When the user views a document via the VIEW DOCUMENT LIBRARY DOCUMENTS program 237, the document displayed to the user indicates within the document where there are unclosed hits recorded in the hits 259 database. In another embodiment, the VIEW DOCUMENT LIBRARY DOCUMENTS program 237 also displays the information in the hits 259 database and allows the user to mark hits as being closed.

The document preparation system 140 shown in FIG. 2 is a general-purpose computer. A bus 241 is a communication medium that connects a CPU 242, data storage 243, network adapter 244, and memory 245. The network adapter 244 also connects to the communication network 110 and is the mechanism that facilitates the passage of network traffic between the document preparation system 140 and the network 110. The CPU 242 performs the disclosed methods by executing the sequences of operational instructions that comprise each computer program resident in, or operative on, the memory 245. It is to be understood that the memory 245 may include operating system, administrative, and database programs that support the programs disclosed in this application.

In one embodiment, the configuration of the memory 245 includes an IDENTIFY CITATIONS program 246, and STORE CITATIONS program 247. These computer programs store intermediate results in the memory 245 or data storage 243. These programs both access the citations 258 database and display the results to the user. In another embodiment, the memory 245 may contain one of these programs, but not both programs.

The IDENTIFY CITATIONS program 246 examines each document that the document preparation system 140 creates or edits to identify a set of references (i.e., citations) in the document. The STORE CITATIONS program 247 transmits the set of references (i.e., citations) to the alert processing system 150 for storage in the citations 258 database. For each citation, the citations 258 database stores the information necessary to identify the linked-to document element, and also the information to specify where that link occurs in the source document. In another embodiment, the IDENTIFY CITATIONS program 246 and STORE CITATIONS program 247 can use the information in the hits 259 database to indicate, when a document is being edited, which elements within the document have unclosed hits recorded in the hits 259 database. In this embodiment, the user can link from each hit to the document that has changed (using the VIEW CHANGED DOCUMENTS program 236 or VIEW DOCUMENT LIBRARY DOCUMENTS program 237 in the document viewing system 130), make changes in the document being edited, and mark the hit as being closed by clearing the closure status for the hit.

The alert processing system 150 shown in FIG. 2 is a general-purpose computer. A bus 251 is a communication medium that connects a CPU 252, data storage 253, network adapter 254, memory 255, citations 258 database, and hits 259 database. The network adapter 254 also connects to the communication network 110 and is the mechanism that facilitates the passage of network traffic between the alert processing system 150 and the network 110. The CPU 252 performs the disclosed methods by executing the sequences of operational instructions that comprise each computer program resident in, or operative on, the memory 255. It is to be understood that the memory 255 may include operating system, administrative, and database programs that support the programs disclosed in this application.

In one embodiment, the configuration of the memory 255 includes a RECEIVE CITATIONS program 256, and DETERMINE HITS program 257. These computer programs store intermediate results in the memory 255 or data storage 253. In another embodiment, the memory 255 may contain one of these programs, but not both programs.

The RECEIVE CITATIONS program 256 receives citations from the document preparation system 140 and stores the information associated with the citations in the citations 258 database. The DETERMINE HITS program 257 periodically compares the data stored in the citations 258 database with the data stored in the changed documents 227 database (i.e., documents in the documents 226 database that have changed) and stores a record in the hits 259 database for each changed document. The record contains data that describes each change to such citation in the citations 258 database. The frequency that the DETERMINE HITS program 257 runs is determined by the implementer based on a number of factors including speed, computing efficiency, resource availability, and the frequency of document changes. However, the higher the frequency, the more current the documents in the document preparation system 140 can be.

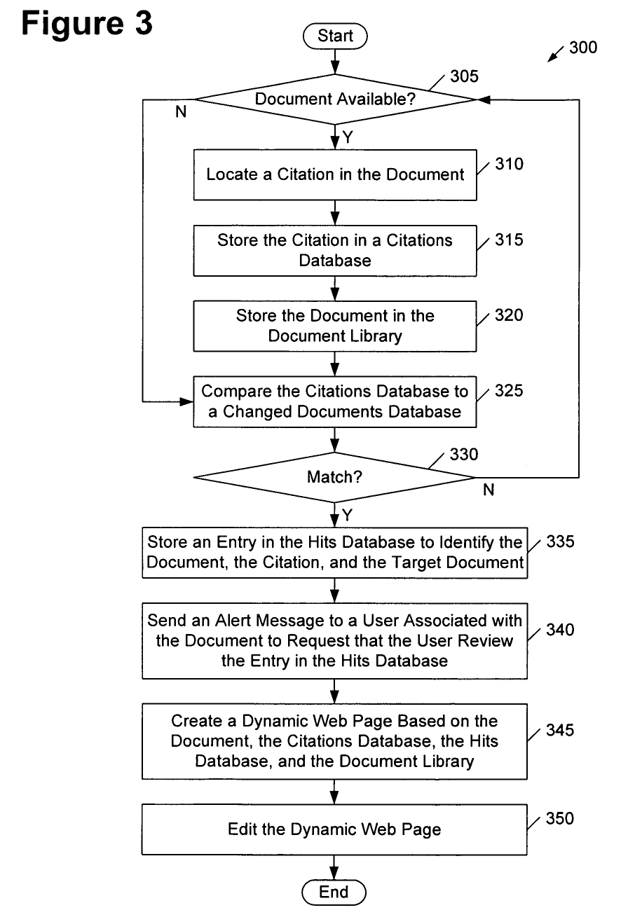

FIG. 3 is a flow chart that illustrates an exemplary embodiment of the method for notifying a user to review a document stored on a computer. The process 300 shown in FIG. 3, with reference where appropriate to the system components shown in FIG. 2, begins by determining whether a document is available for processing (step 305). If a document is available (step 305, “Y” branch), the process 300 scans the document to locate a citation in the document (step 310). In one embodiment, the document is a structured document and the citation is a hypertext link that links text in the structured document to a target document such that when a user displays the structured document using a browser program and select (i.e., clicks) the text, the browser follows the link and displays the target document. The process 300 then stores the citation in a citations 258 database (step 315) and stores the document in a document library 120 (step 320). The process 300 periodically compares the citations 258 database to a changed documents 227 database (step 325). Since this comparison occurs periodically, the process 300 may perform the comparison when no document is available for processing (step 305, “N” branch). If the comparison determines for every citation in the citations 258 database, that the target document associated with the citation has not changed (step 330, “N” branch), then the process 300 returns to determining whether a document is available for processing (step 305). If a target document associated with a citation in the citations 258 database has changed (step 330, “Y” branch), the process 300 stores an entry in the hits 259 database to identify the document, the citation, and the target document (step 335). Then, the process 300 sends an alert message to a user associated with the document to request that the user review the entry in the hits 259 database (step 340). In one embodiment, the user is a person who is responsible for updating and maintaining the document. When the user receives the alert message and decides to review the entry in the hits 259 database, the process 300 creates a dynamic web page which is based on the document and other sources including the citations 258 database, the hits 259 database, and the document library 120 (step 345). In another embodiment, the user may decide to review the entries in the hits 259 database without receiving an alert message. If the user determines that the change to the target document necessitates a change to the document, the user edits the dynamic web page to reflect the change to the target document (step 350). In one embodiment, when the user views the dynamic web page using a browser program, the appearance of each citation in the dynamic web page that is also in the hits 259 database will differ from the appearance of other citations.

Although the disclosed exemplary embodiments describe a fully functioning system and method for notifying a user to review a document stored on a computer, the reader should understand that other equivalent exemplary embodiments exist. Since numerous modifications and variations will occur to those reviewing this disclosure, the system and method for notifying a user to review a document stored on a computer is not limited to the exact construction and operation illustrated and disclosed. Accordingly, this disclosure intends all suitable modifications and equivalents to fall within the scope of the claims.

We claim:

1. A method for notifying a user to review a document stored on a computer, comprising:
identifying a citation in the document, wherein the citation is a link to a target document;
storing the citation in a citations database;
comparing the citations database to a changed documents database;
storing an entry in a hits database when the comparison determines that the target document is a changed document, wherein the entry identifies the document, the citation, and the target document; and
sending an alert message to the user to request that the user review the entry in the hits database.

2. The method of claim 1, wherein the document is a structured document, and wherein the citation is a hypertext link in the structured document.

3. The method of claim 1, wherein the target document is a structured target document having a plurality of document elements, and wherein the citation is a link to a document element of the structured target document.

4. The method of claim 3, wherein the comparison determines that the target document is a changed document when the change is to the document element to which the citation is linked.

5. The method of claim 1, wherein the identifying of the citation in the document further comprises:
receiving the document;
scanning the document to locate the citation; and
storing the document in a document library.

6. The method of claim 1, wherein the storing of the citation further comprises:
storing a citation string;
storing an identifier of the document that contains the citation string;
storing a location of the citation string in the document;
storing an identifier of the target document that the citation string references; and
storing a location in the target document that the citation string references.

7. The method of claim 1, wherein the comparison occurs periodically, with a frequency selected based on a number of factors including speed, computing efficiency, resource availability, and number and frequency of document changes.

8. The method of claim 1, wherein the storing of the entry in the hits database further comprises:
storing the citation; and
storing a description of the change to the target document.

9. The method of claim 1, wherein the alert message includes an electronic mail message, instant message, text message, voice message, or the like.

10. The method of claim 1, further comprising:
creating a dynamic web page by merging the document with data obtained from other sources, including the citations database, the hits database, and a document library; and
displaying the dynamic web page.

11. The method of claim 10, wherein the user is responsible for maintaining the document, further comprising:
editing the dynamic web page based on a change in the target document.

12. The method of claim 11, wherein the editing is automated.

13. The method of claim 11, wherein an appearance of the citation in the dynamic web page indicates whether the editor has reviewed the entry in the hits database associated with the citation.

14. The method of claim 1, further comprising:
selecting an entry from the hits database;
displaying the document and target document associated with the selected entry for the user to review; and
marking the selected entry to indicate that the selected entry was reviewed.

15. The method of claim 14, further comprising:
associating a comment with the selected entry.

16. A system for notifying a user to review a document stored on a computer, comprising:
a memory device resident in the computer;
a processor disposed in communication with the memory device, the processor configured to:
identify a citation in the document, wherein the citation is a link to the target document;
store the citation in a citations database;
compare the citations database to a changed documents database;
store an entry in a hits database when the comparison determines that the target document is a changed document, wherein the entry identifies the document, the citation, and the target document; and
send an alert message to the user to request that the user review the entry in the hits database.

17. The system of claim 16, wherein the target document is a structured target document having a plurality of document elements, wherein the citation is a link to a document element of the structured target document, and wherein to perform the comparison, the processor is configured to determine that the target document is a changed document when the change is to the document element to which the citation is linked.

18. The system of claim 16, wherein to identify the citation in the document, the processor is further configured to:
receive the document;
scan the document to locate the citation; and
store the document in a document library.

19. The system of claim 16, wherein to store the citation, the processor is further configured to:
store a citation string;
store an identifier of the document that contains the citation string;
store a location of the citation string in the document;
store an identifier of the target document that the citation string references; and
store a location in the target document that the citation string references.

20. The system of claim 16, wherein the processor is further configured to perform the comparison periodically, with a frequency selected based on a number of factors including speed, computing efficiency, resource availability, and number and frequency of document changes.

21. The system of claim 16, wherein to store the entry, the processor is further configured to:
store the citation; and
store a description of the change to the target document.

22. The system of claim 16, wherein the processor is further configured to:
create a dynamic web page by merging the document with data obtained from other sources, including the citations database, the hits database, and a document library; and
display the dynamic web page.

23. The system of claim 22, wherein the user is responsible for maintaining the document, and wherein the processor is further configured to:
edit the dynamic web page based on a change in the target document.

24. The system of claim 23, wherein the processor is further configured to automate the editing.

25. The system of claim 16, wherein the processor is further configured to:
select an entry from the hits database;
display the document and target document associated with the selected entry for the user to review; and
mark the selected entry to indicate that the selected entry was reviewed.

26. The system of claim 25, wherein the processor is further configured to:
associate a comment with the selected entry.
